(19) United States
(12) Patent Application Publication
(10) Pub. No.: US 2021/0391901 A1
(43) Pub. Date: Dec. 16, 2021

(54) COMMUNICATION CONTROL APPARATUS, COMMUNICATION CONTROL METHOD, COMMUNICATION APPARATUS, AND COMMUNICATION METHOD

(71) Applicant: Sony Group Corporation, Tokyo (JP)

(72) Inventor: Osamu YOSHIMURA, Tokyo (JP)

(73) Assignee: Sony Group Corporation, Tokyo (JP)

(21) Appl. No.: 17/288,568

(22) PCT Filed: Nov. 15, 2019
(86) PCT No.: PCT/JP2019/044821

§ 371 Date: Apr. 26, 2021

(30) Foreign Application Priority Data
Nov. 29, 2018 (JP) 2018-223113

(51) Int. Cl. H04B 7/06; H04B 7/08; H04W 16/28

(52) U.S. Cl. CPC H04B 7/0617; H04B 7/086; A63F 13/332; H04W 16/28; H04B 7/088

(57) ABSTRACT

The present technology relates to a communication control apparatus, a communication control method, a communication apparatus, and a communication method for improving communication robustness.

A control section causes a wireless communication section performing wireless communication to execute beam forming setting in a manner linked with content. The present technology can be applied to wireless communication systems that use millimeter waves.

### TECHNICAL FIELD

The present technology relates to a communication control apparatus, a communication control method, a communication apparatus, and a communication method. More particularly, the present technology relates to a communication control apparatus, a communication control method, a communication apparatus, and a communication method for improving communication robustness.

### BACKGROUND ART

Millimeter wave wireless communication is characterized by a very large amount of transmitted information, high linear propagation characteristics, and high distance attenuation. In millimeter wave wireless communication, transfer loss is reduced by use of beam forming (BF) technology that involves concentrating radio waves in a specific direction.

In the case where a communication target is moving, the use of BF tracking is essential in keeping with the activity of the communication target. In this case, executing BF too often can reduce actual data communication bandwidth. Thus, it has been proposed that BF be carried out in the case where communication status deteriorates (see PTL 1).

### CITATION LIST

### Patent Literature

### PTL 1

Japanese Patent Laid-open No. 2016-178625

### SUMMARY

### Technical Problem

In the case where BF is performed after communication status has deteriorated, the rate of transmission temporarily drops. This can result in deterioration or disturbance of images during communication.

The present technology has been devised in view of the above circumstances and is aimed at improving communication robustness.

### Solution to Problem

According to a first aspect of the present technology, there is provided a communication control apparatus including a control section configured to cause a communication section performing wireless communication to execute beam forming setting in a manner linked with content.

Thus, according to the first aspect of the present technology, the beam forming setting is executed in a manner linked with content by the communication section performing wireless communication.

According to a second aspect of the present technology, there is provided a communication apparatus including a communication section configured to execute beam forming setting of wireless communication in conjunction with another communication apparatus, under such control that the beam forming setting is executed in a manner linked with content.

Thus, according to the second aspect of the present technology, beam forming setting of wireless communication is executed in conjunction with another communication apparatus, under such control that the beam forming setting is executed in a manner linked with content.

### BRIEF DESCRIPTION OF DRAWINGS

FIG. 1 is a schematic diagram depicting a configuration example of a wireless communication system to which the present technology is applied.

FIG. 2 is a block diagram depicting a configuration example of an entertainment apparatus 11.

FIG. 3 is a block diagram depicting a configuration example of a wireless repeating apparatus 12.

FIG. 4 is a block diagram depicting a configuration example of an HMD 13.

FIG. 5 is a schematic diagram depicting an example of BF training.

FIG. 6 is a schematic diagram depicting an example of receive BF tracking on an initiator side.

FIG. 7 is a schematic diagram depicting an example of transmit BF tracking on the initiator side.

FIG. 8 is a schematic diagram depicting an example of data placement in content reproduced by the entertainment apparatus 11.

FIG. 9 is a schematic diagram depicting a typical scene in content.

FIG. 10 is a flowchart explaining a first process of the wireless communication system.

FIG. 11 is a flowchart explaining a BF setting detection process in step S11 of FIG. 10.

FIG. 12 is a flowchart explaining a BF setting process in step S21 of FIG. 10.

FIG. 13 is a flowchart explaining a second process of the wireless communication system.

FIG. 14 is a flowchart explaining a third process of the wireless communication system.

FIG. 15 is a flowchart explaining a fourth process of the wireless communication system.

FIG. 16 is a block diagram depicting a configuration example of the entertainment apparatus 11.

FIG. 17 is another flowchart explaining the BF setting detection process in step S11 of FIG. 10.

FIG. 18 is a block diagram depicting a configuration example of the HMD 13.

FIG. 19 is a flowchart explaining processing of a wireless communication system of a third alternative example.

FIG. 20 is a block diagram depicting a hardware configuration example of a computer.

### DESCRIPTION OF EMBODIMENTS

Preferred embodiments for implementing the present technology are described below. The description will be given in the following order.

1. Wireless communication system

2. Configuration example of individual apparatuses

3. Examples of BF

4. Content format example

5. Operations of the wireless communication system

6. Alternative examples of the wireless communication system

7. Computer

### <1. Wireless Communication System>

### <Configuration Example of the Wireless Communication System>

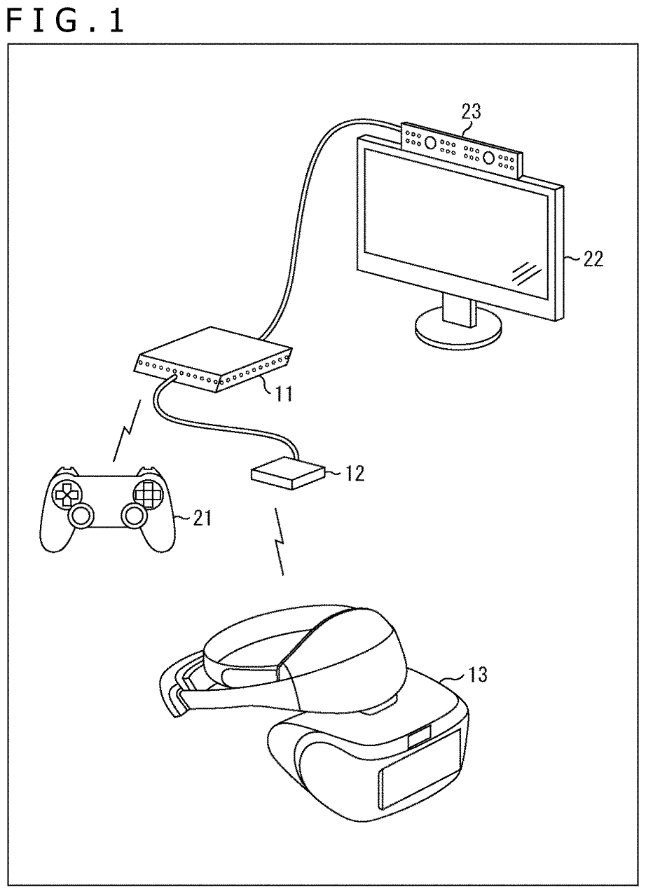

FIG. 1 depicts a configuration example of a wireless communication system as one embodiment of the present technology.

The wireless communication system in FIG. 1 includes an entertainment apparatus 11, a wireless repeating apparatus 12, and an HMD (Head Mount Display) 13. The entertainment apparatus 11 is connected with a controller 21, a display apparatus 22, and a camera/microphone unit 23.

The entertainment apparatus 11 is connected with the wireless repeating apparatus 12 by means of an HDMI (registered trademark) cable, a USB cable, or an Ethernet (registered trademark) cable, for example.

In FIG. 1, the entertainment apparatus 11 and the wireless repeating apparatus 12 are each configured as a single apparatus. Alternatively, the wireless repeating apparatus 12 may be built in the entertainment apparatus 11. That is, in the case where the wireless repeating apparatus 12 is incorporated in the entertainment apparatus 11, the wireless repeating apparatus 12 functions as a wireless communication section of the entertainment apparatus 11.

The wireless repeating apparatus 12 and the HMD 13 exchange data therebetween by millimeter wave wireless communication. Millimeter wave wireless communication is characterized by a very large amount of transmitted information, high linear propagation characteristics, and high distance attenuation. Given these characteristics, transfer loss in millimeter wave wireless communication is reduced by recourse to beam forming (BF) technology that involves concentrating radio waves in a specific direction.

The entertainment apparatus 11 includes a game console, a DVD player, a personal computer, a smartphone, or a tablet terminal, for example.

The entertainment apparatus 11 generates images and sounds by executing game programs stored in a memory or on a hard disk, for example. The entertainment apparatus 11 produces images and sounds by reproducing the content stored on optical disks, for example. Image signals corresponding to the images and sound signals corresponding to the sounds are transmitted to the HMD 13 by way of the wireless repeating apparatus 12.

Some content includes scenes (situations) that may cause the user of the HMD 13 to move or act while viewing or listening to the content. Such content may include such scenes as car chases, car collision, a hooligan threatening with a fist, or collective three cheers that may prompt or invite the user of the HMD 13 to move or to act. In the description that follows, such movements and actions of the user will be referred to as the user's activity where appropriate. Such scenes inducing the user's activity will be referred to as the scenes in which the user's activity is predicted to occur.

In content, the data of the scenes in which the user's activity is predicted to occur is prefixed with meta information. In the BF of millimeter wave wireless communication, the meta information is parameters related to BF setting, which involves setting the direction of radio waves. The parameters related to the BF setting include a BF setting start trigger, for example.

The entertainment apparatus 11 executes the BF setting in a manner linked with content. That is, the entertainment apparatus 11 extracts meta information by analyzing content and, on the basis of the extracted meta information, generates execution information regarding BF setting. The execution information regarding the BF setting is the information for executing the BF setting, and includes at least one of the parameters included in the meta information. The BF setting execution information is output to the wireless repeating apparatus 12.

The controller 21 outputs signals reflecting the user's operations to the entertainment apparatus 11. The display apparatus 22 displays images corresponding to the image signals generated by the entertainment apparatus 11.

The camera/microphone unit 23 includes an imaging section and a microphone. The imaging section generates images by capturing a subject. The images thus generated are output to the entertainment apparatus 11. The microphone picks up sounds. The sounds thus picked up are output to the entertainment apparatus 11.

The wireless repeating apparatus 12 transmits image signals and sound signals to the HMD 13 by millimeter wave wireless communication. The wireless repeating apparatus 12 executes the BF setting in conjunction with the HMD 13 on the basis of the BF setting execution information supplied from the entertainment apparatus 11. The BF setting is carried out by an apparatus on the initiator side and by an apparatus on the responder side. It is to be noted that explained in the ensuing paragraphs are cases in which the wireless repeating apparatus 12 is the apparatus on the initiator side. The HMD 13 is the apparatus on the responder side.

The HMD 13 displays images corresponding to the image signals supplied from the wireless repeating apparatus 12, and outputs sounds corresponding to the sound signals supplied therefrom.

The HMD 13 is worn on the user's head. The user views images displayed by the HMD 13 in front of the eyes while hearing the sounds output therefrom. Depending on the scene of the content displayed by the HMD 13, the user may move or act over a wide range.

The HMD 13 executes the BF setting in conjunction with the wireless repeating apparatus 12 on the basis of the BF setting execution information. As described above, the BF setting is triggered by the BF setting execution information generated by the entertainment apparatus 11 on the basis of the meta information extracted by analyzing content.

In the wireless communication system, the BF setting is thus executed prior to scenes in which the user's activity is predicted to occur. This makes it possible to prevent a decrease in the transmission rate of wireless communication or the occurrence of an error even if the user of the HMD 13 moves or acts over a wide range due to the scene of the content displayed on the HMD 13.

That in turn improves the robustness of millimeter wave wireless communication. This prevents deterioration of image quality or irregularities of images attributable to a decrease in transmission rate.

### <2. Configuration Example of Individual Apparatuses>

### <Configuration Example of the Entertainment Apparatus>

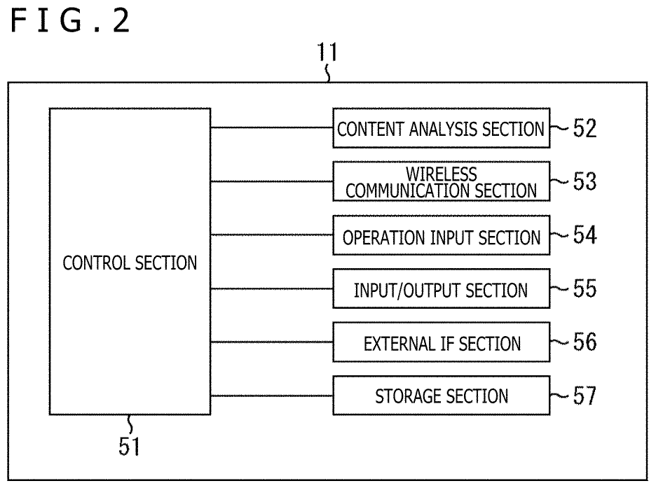

FIG. 2 is a block diagram depicting a configuration example of the entertainment apparatus 11.

The entertainment apparatus 11 includes a control section 51, a content analysis section 52, a wireless communication section 53, an operation input section 54, an input/output section 55, an external IF (interface) section 56, and a storage section 57. The content analysis section 52, the wireless communication section 53, the operation input section 54, the input/output section 55, the external IF section 56, and the storage section 57 are connected with the control section 51.

The control section 51 causes a CPU to execute predetermined programs to perform diverse arithmetic processing and operation control of the various sections. By so doing, the control section 51 controls the operations of the entertainment apparatus 11 as a whole.

For example, the control section 51 generates images and sounds by executing game programs stored in the storage section 57. The control section 51 generates images and sounds by reproducing content stored on optical disks, for example. The image signals and sound signals corresponding to the images and sounds are transmitted to the wireless repeating apparatus 12 via the external IF section 56.

The control section 51 generates BF setting execution information, based on the meta information supplied from the content analysis section 52. The BF setting execution information is transmitted to the wireless repeating apparatus 12 via the external IF section 56.

The content analysis section 52 analyzes the currently reproduced content so as to extract the meta information included in the content. The meta information is output to the control section 51.

The wireless communication section 53 wirelessly communicates with a mobile terminal such as a smartphone by Bluetooth (registered trademark) connection or via a wireless LAN module, for example.

The operation input section 54 includes the controller 21, switches, a touch sensor panel, and an operation panel, for example. The operation input section 54 accepts input of instructions or settings, based on the user's operations.

The input/output section 55 includes sensors, indicators, and speakers, for example.

The external IF section 56 transmits to the wireless repeating apparatus 12 the image signals and sound signals corresponding to the images and sounds supplied from the control section 51. The external IF section 56 transmits to the wireless repeating apparatus 12 the BF setting execution information supplied from the control section 51.

The storage section 57 includes a memory and a hard disk, for example. The storage section 57 stores game programs, content, predetermined programs, or various kinds of data. The game programs and predetermined programs are executed by the control section 51.

### <Configuration Example of the Wireless Repeating Apparatus>

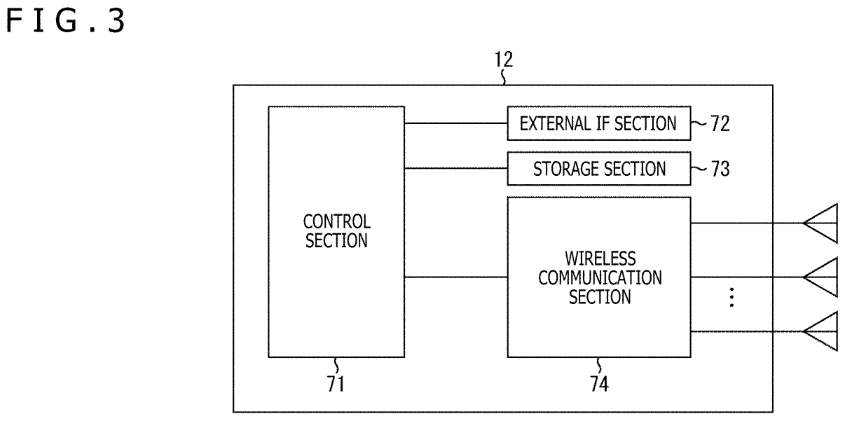

FIG. 3 is a block diagram depicting a configuration example of the wireless repeating apparatus 12.

The wireless repeating apparatus 12 includes a control section 71, an external IF section 72, a storage section 73, and a wireless communication section 74. The external IF section 72, the storage section 73, and the wireless communication section 74 are connected with the control section 71.

The control section 71 causes a CPU to execute predetermined programs to perform diverse arithmetic processing and operation control of the various sections. By so doing, the control section 71 controls the operations of the wireless repeating apparatus 12 as a whole.

For example, the control section 71 causes the wireless communication section 74 to transmit the image signals and sound signals received via the external IF section 72. Further, the control section 71 causes the wireless communication section 74 to execute the BF setting, based on the BF setting execution information received via the external IF section 72.

The external IF section 72 receives the image signals and sound signals transmitted from the entertainment apparatus 11, and outputs the image signals and sound signals to the control section 71. The external IF section 72 receives the BF setting execution information transmitted from the entertainment apparatus 11, and outputs the BF setting execution information to the control section 71.

The storage section 73 includes a memory and a hard disk, for example. The storage section 73 stores predetermined programs or various kinds of data to be executed by the control section 71.

The wireless communication section 74 exchanges data with the HMD 13 by millimeter wave wireless communication. The wireless communication section 74 transmits to the HMD 13 the image signals and sound signals supplied via the external IF section 72. The wireless communication section 74 executes the BF setting in conjunction with the HMD 13, according to the timing supplied from the control section 71.

### <Configuration Example of the HMD>

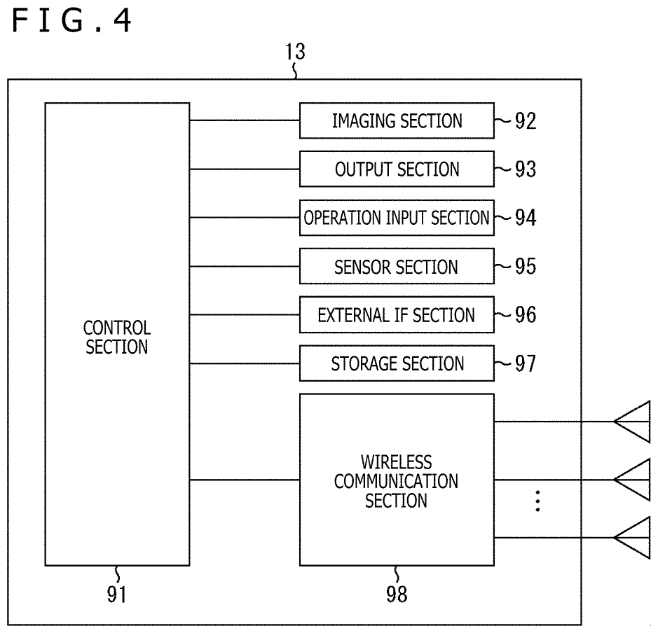

FIG. 4 is a block diagram depicting a configuration example of the HMD 13.

The HMD 13 includes a control section 91, an imaging section 92, an output section 93, an operation input section 94, a sensor section 95, an external IF section 96, a storage section 97, and a wireless communication section 98. The imaging section 92, the output section 93, the operation input section 94, the sensor section 95, the external IF section 96, the storage section 97, and the wireless communication section 98 are connected with the control section 91.

The control section 91 causes a CPU to execute predetermined programs to perform diverse arithmetic processing and operation control of the various sections. By so doing, the control section 91 controls the operations of the HMD 13 as a whole.

For example, the control section 91 superposes two kinds of images one on top of the other, one kind of image corresponding to the image signal supplied from the wireless communication section 98, the other kind of image corresponding to the image signal fed from the imaging section 92, the superposed images being output to an LCD of the output section 93. The control section 91 outputs to speakers of the output section 93 the sounds corresponding to the sound signals supplied from the wireless communication section 98. The control section 91 outputs to a vibrator of the output section 93 vibrations corresponding to the image signals or sound signals supplied from the wireless communication section 98.

The imaging section 92 generates images by capturing a subject. The imaging section 92 supplies the control section 91 with the image signals representing the generated images.

The output section 93 includes a display, speakers, and a vibrator, for example. The display outputs images corresponding to the image signals supplied from the control section 91. The speakers output sounds corresponding to the sound signals supplied from the control section 91. The vibrator outputs vibrations corresponding to the image signals or sound signals supplied from the control section 91.

The operation input section 94 includes switches and a touch sensor panel, for example. The operation input section 94 accepts input of instructions or settings, based on the user's operations.

The sensor section 95 is arranged on the housing of the HMD 13, for example. The sensor section 95 includes at least one of such sensors as an acceleration sensor, an angular velocity sensor, a geomagnetic sensor, an illuminance sensor, a temperature sensor, a humidity sensor, an atmospheric pressure sensor, and a positioning sensor. The sensor section 95 performs measurement at predetermined time intervals and supplies sensor data representing the measurement results to the control section 91.

The external IF section 96 receives the image signals and sound signals from other apparatuses, and outputs the image signals and sound signals to the control section 91.

The storage section 97 includes a memory and a hard disk, for example. The storage section 97 stores predetermined programs or various kinds of data to be executed by the control section 91.

The wireless communication section 98 exchanges data with the wireless repeating apparatus 12 by millimeter wave wireless communication. The wireless communication section 98 outputs to the control section 91 the image signals and sound signals transmitted from the wireless repeating apparatus 12. The wireless communication section 98 executes the BF setting which is started by the wireless repeating apparatus 12, in conjunction therewith.

### <3. Examples of BF>

### <Operation Example of the BF Setting>

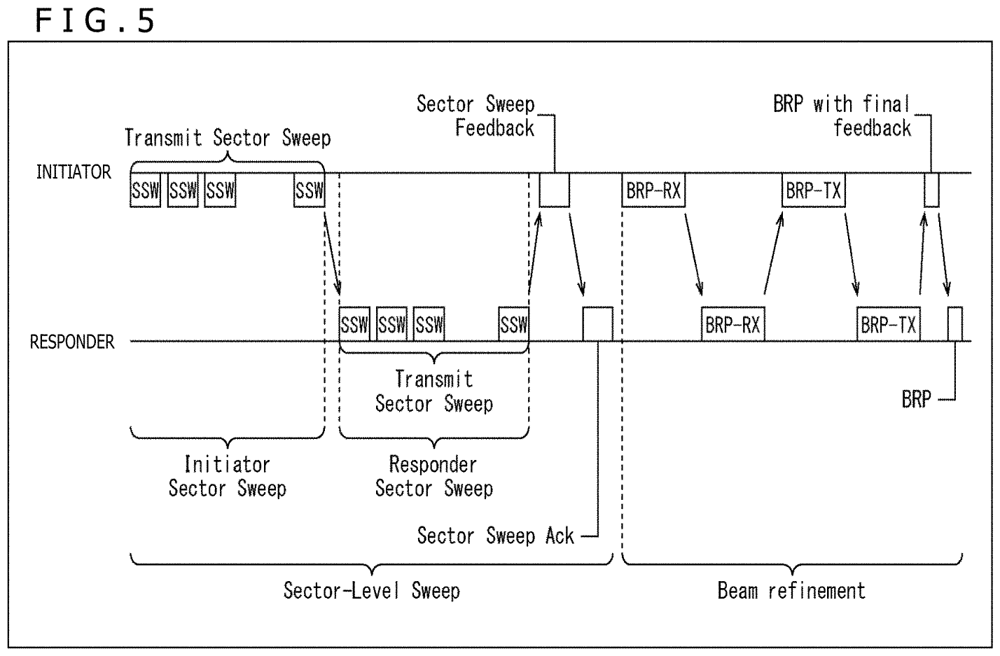

FIG. 5 depicts an example of BF training.

The BF training depicted in FIG. 5 is an example of BF including Sector-Level Sweep and Beam refinement prescribed by IEEE 802.11-2016.

The BF training is executed between an initiator and a responder. The initiator starts the BF. Upon receipt of an instruction from the initiator, the responder executes the BF.

Sector-Level Sweep includes Initiator Sector Sweep, Responder Sector Sweep, Sector Sweep Feedback, and Sector Sweep Ack.

Upon start of the BF training, Initiator Sector Sweep is performed. In Initiator Sector Sweep, the initiator transmits an SSW (sector sweep) packet a predetermined number of times while changing the directions of the antenna and radio waves. The responder receives the packets transmitted from the initiator.

After Initiator Sector Sweep, Responder Sector Sweep is carried out. In Responder Sector Sweep, the responder transmits an SSW packet a predetermined number of times while changing the directions of the antenna and radio waves.

After Responder Sector Sweep, the initiator transmits to the responder information constituting Sector Sweep Feedback indicative of the packet received by optimum radio waves from among the packets transmitted from the responder. The responder transmits to the responder information constituting Sector Sweep Ack indicative of the packet received by optimum radio waves from among the packets received from the initiator.

After Sector-Level Sweep, Beam refinement (beam adjustment) is performed. The initiator adjusts the intensity and direction of radio waves as Beam refinement, and transmits a BRP (Beam refinement Protocol)-RX packet.

The responder receives the BRP-RX packet transmitted from the initiator and adjusts a reception beam accordingly. The responder adjusts the intensity and direction of radio waves and transmits a BRP-RX packet. The initiator receives the BRP-RX packet transmitted from the responder, and adjusts the reception beam accordingly.

The initiator finely adjusts the intensity and direction of radio waves and transmits a BRP-TX packet. The responder receives the BRB-TX packet transmitted from the initiator. The responder finely adjusts the intensity and direction of radio waves and transmits a BRP-TX packet.

The initiator receives the BRP-TX packet transmitted from the responder. The initiator transmits, using a BRP packet, information indicative of the sector received by optimum radio waves. The responder receives the BRP packet transmitted from the initiator, and adjusts the transmission beam accordingly. The responder transmits, using a BRP packet, information indicative of the sector received by optimum radio waves. The initiator receives the BRP packet transmitted from the responder, and adjusts a transmission beam accordingly.

In the manner described above, the initiator side identifies the direction of optimum radio waves transmitted from the initiator side. The responder side identifies the direction of optimum radio waves transmitted from the responder side. In the wireless communication system, the above-described BF training is executed as the BF setting.

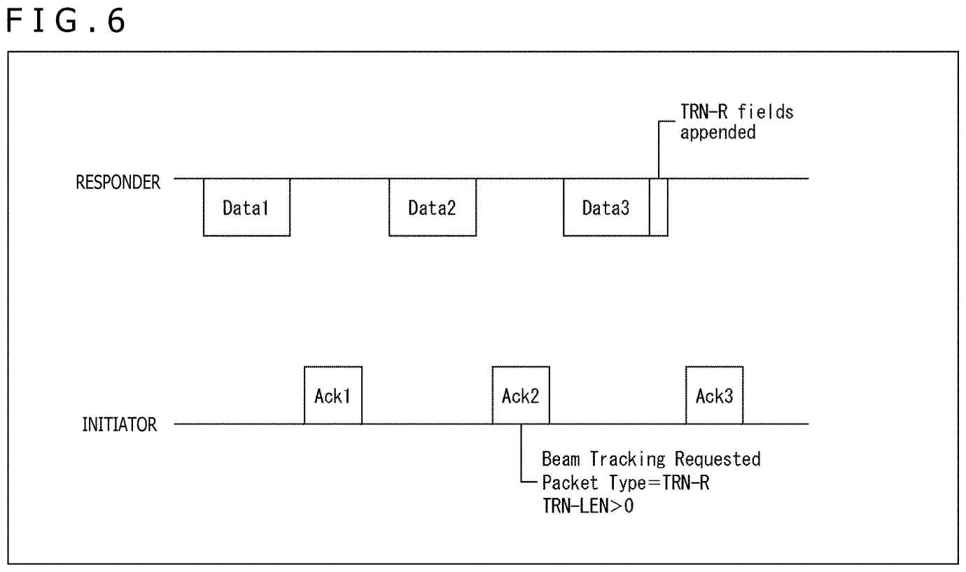

FIG. 6 depicts an example of receive BF tracking on the initiator side.

As depicted in FIG. 6, the responder transmits Data 1. In the case of receiving Data 1 transmitted from the responder, the initiator transmits Ack 1. Ack is information indicating that Data has been received. In the case where Ack is not received by the Data transmitting side, Data is retransmitted.

In the case of receiving Ack 1 transmitted from the initiator, the responder transmits Data 2. In the case of receiving Data 2 transmitted from the responder, the initiator transmits Ack 2. Ack 2 includes a receive BF tracking request from the initiator side.

In the case of receiving the request included in Ack 2 transmitted from the initiator, the responder transmits Data 3 and TRN-R fields. TRN-R fields constitute receive BF-use data for the initiator side. In the case of receiving Data 3 and TRN-R fields, the initiator tracks radio waves to adjust their intensity and direction, before transmitting Ack 3.

In the manner described above, the initiator side identifies the direction in which optimum radio waves transmitted from the responder side is to be received. In the wireless communication system, the above-described BF tracking may be executed as the BF setting.

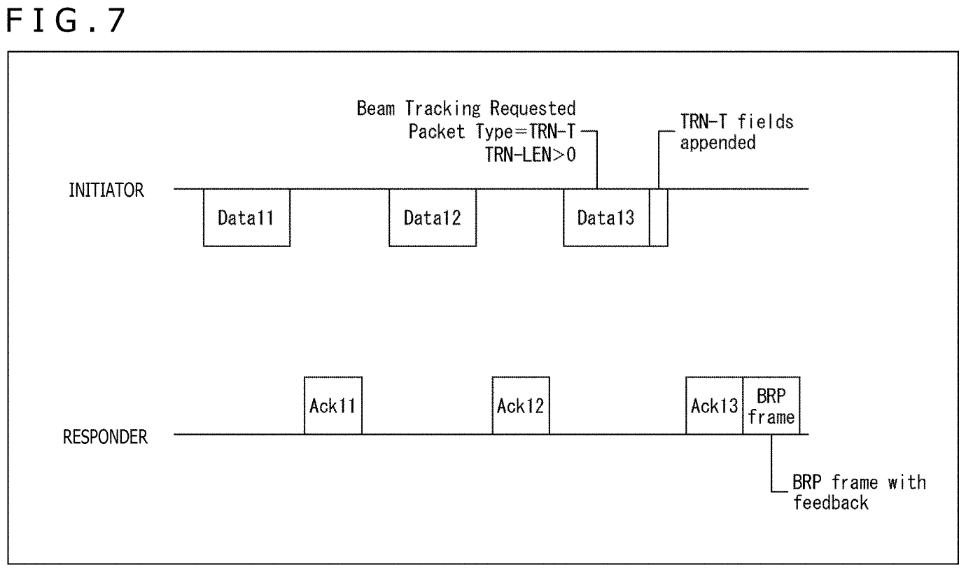

FIG. 7 depicts an example of transmit BF tracking on the initiator side.

As depicted in FIG. 7, the initiator transmits Data 11. In the case of receiving Data 11 transmitted from the initiator, the responder transmits Ack 11. In the case of receiving Ack 11 transmitted from the responder, the initiator transmits Data 12. In the case of receiving Data 12 transmitted from the initiator, the responder transmits Ack 12.

The initiator receives Ack 12 transmitted from the responder. In the case of adjusting the transmission beam, the initiator transmits Data 13 and TRN-T fields. At this time, Data 13 includes a transmit BF tracking request as a packet type from the initiator side. TRN-T fields constitute BF-use data for the transmitting side.

In the case of receiving Data 13 and TRN-R fields transmitted from the initiator, the responder transmits Ack 13 and a BRP frame. The BRP frame is added with a feedback of the information indicative of the sector received by optimum radio waves.

In the manner described above, the initiator side identifies the direction of optimum radio waves transmitted from the initiator side. In the wireless communication system, the above-described BF tracking may be executed as the BF setting.

Incidentally, not only the above-described BF training or BF tracking but also all BF methods suitable for executing the BF setting may be used as the method for the BF setting.

### <4. Content Format Example>

### <Content Format Example>

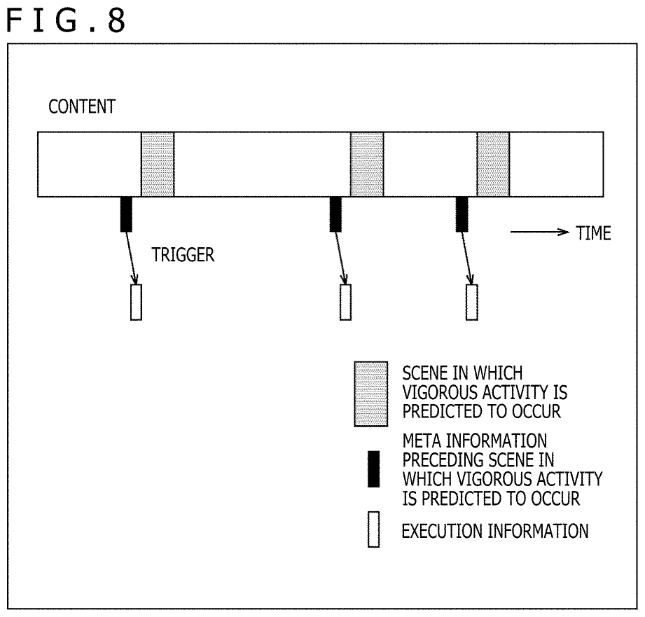

FIG. 8 depicts an example of data placement in content reproduced by the entertainment apparatus 11.

In FIG. 8, a right-pointing arrow indicates the passage of time.

In the content data, hatched portions carry the data of scenes in which the user's vigorous activity is predicted to occur. Dark rectangles under the content data represent meta information placed preceding the scenes where the user's vigorous activity is predicted to occur. Blank rectangles each pointed to by an arrow extending from the meta information represent the BF setting execution information generated on the basis of the meta information.

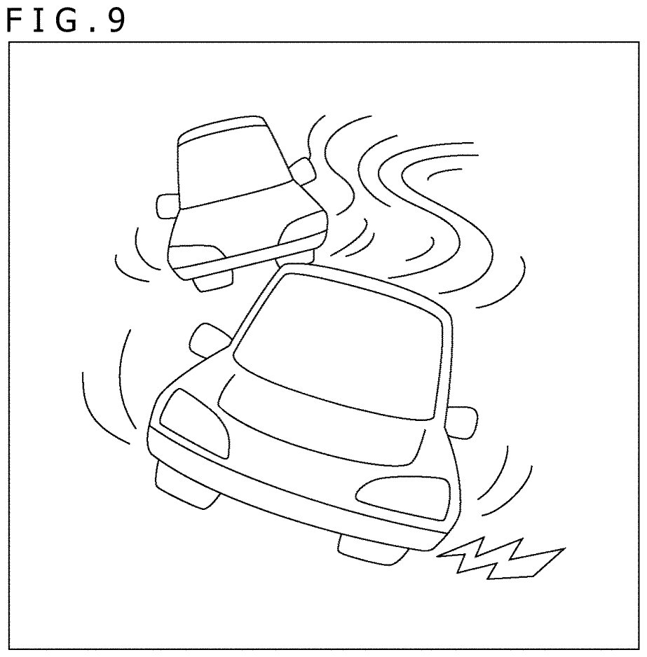

FIG. 9 depicts a typical scene in the content.

Depicted in FIG. 9 is a scene in which two cars are racing at high speed in a zigzag.

When viewing such a highly active scene as the one in FIG. 9, the user may lean forward or sway his or her body right and left. Thus, the meta information, as indicated by the dark rectangles in FIG. 8, is placed temporally before the data of each scene in which the user's vigorous activity is predicted to occur.

Alternatively, the meta information may be placed preceding scenes in which not only the vigorous activity but also any activity is predicted to occur.

The entertainment apparatus 11 analyzes the content to extract the meta information placed therein in the above manner.

The meta information placed in the content includes BF-related parameters such as a BF setting start trigger (start time), a BF setting end trigger (end time), a BF sequence count, a BF range, a BF pattern, a BF cycle, and a BF threshold value.

The BF sequence count is the number of times the BF setting is to be executed. The BF range is an amplitude of the direction of radio waves. The BF pattern is information indicative of combinations of the direction of the antenna for transmitting radio waves and the direction of radio waves, for example.

The BF cycle means a cycle of the BF setting. The BF threshold value is a threshold value used for determining the optimum radio waves for reception. For example, in the case where the intensity of received radio waves is less than the threshold value, the BF setting is executed again or stopped.

The entertainment apparatus 11 generates BF setting execution information, based on meta information. The BF setting execution information includes at least one of the parameters included in the meta information. The BF setting execution information may include all parameters included in the meta information or only necessary parameters included therein. The BF setting execution information generated by the entertainment apparatus 11 is output to the wireless repeating apparatus 12.

### <5. Operations of the Wireless Communication System>

### <First Process Example>

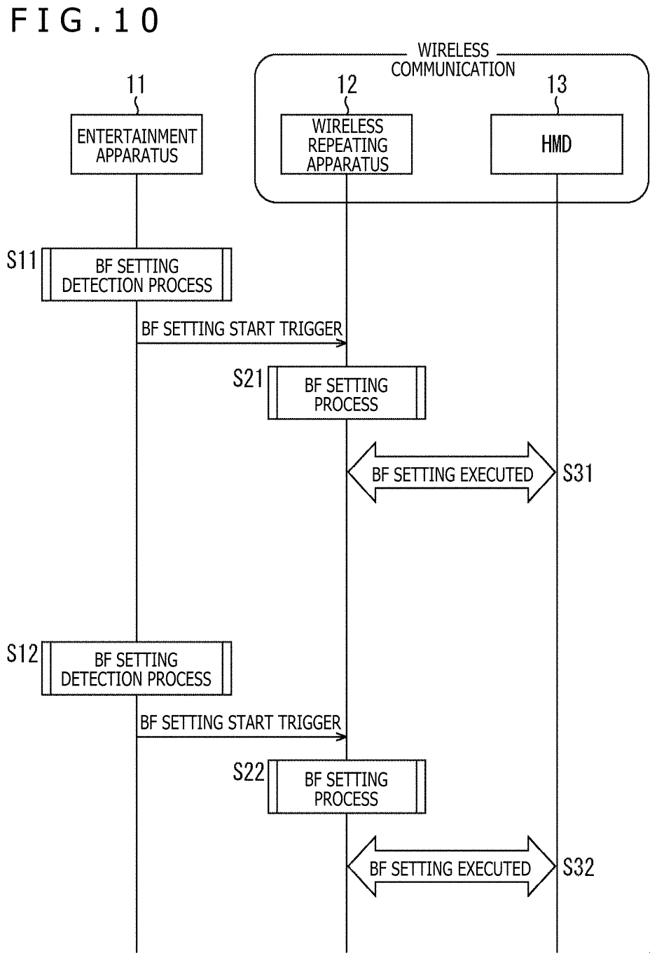

FIG. 10 is a flowchart explaining a first process of the wireless communication system.

The first process depicted in FIG. 10 is performed in the case where a BF setting start trigger is included as the meta information. The process in FIG. 10 is started when content is being reproduced by the entertainment apparatus 11.

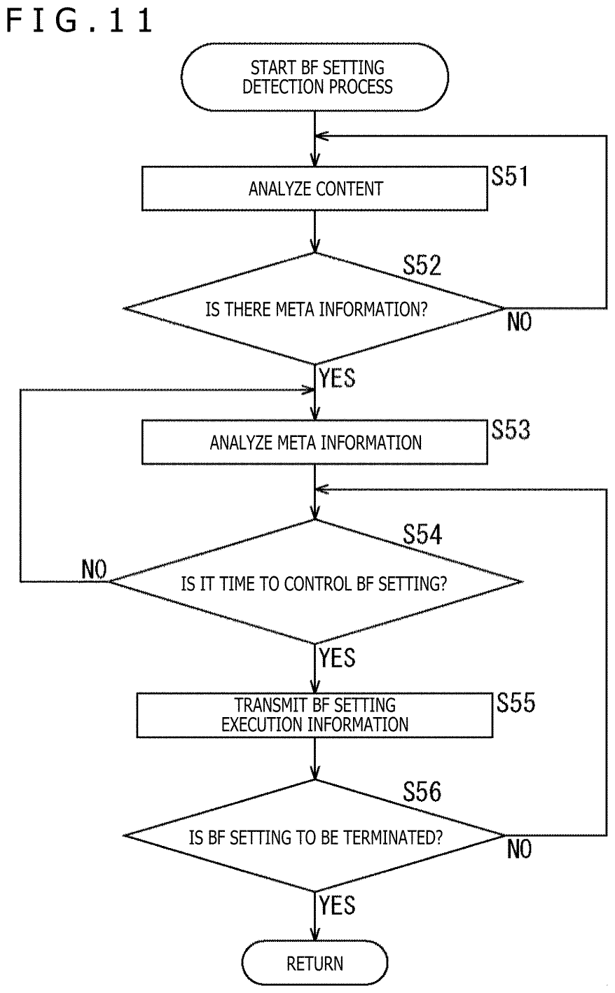

In step S11, the entertainment apparatus 11 performs a BF setting detection process. The BF setting detection process will be discussed later with reference to FIG. 11. When the BF setting detection process is carried out in step S11, the BF setting start trigger is output to the wireless repeating apparatus 12 as the BF setting execution information.

Incidentally, the start trigger may be an instruction using a message or a physical electric signal.

The wireless repeating apparatus 12 receives the BF setting execution information transmitted from the entertainment apparatus 11.

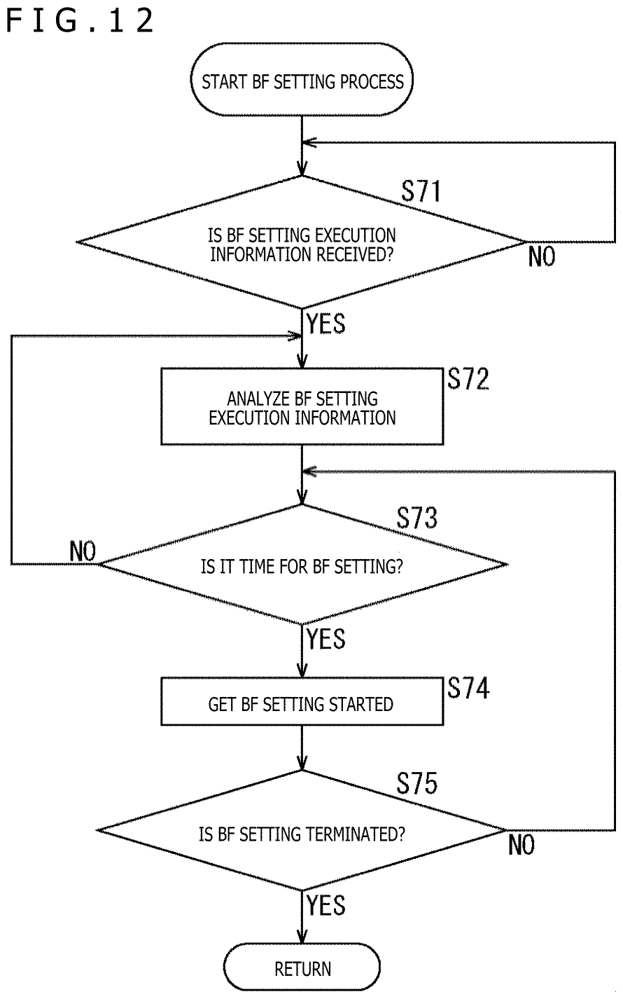

In step S21, the wireless repeating apparatus 12 performs a BF setting process. The BF setting process will be discussed later with reference to FIG. 12. The BF setting process causes the BF setting to be executed.

Corresponding to the processing of the wireless repeating apparatus 12, the HMD 13 executes the BF setting in step S31 in conjunction with the wireless repeating apparatus 12. It is to be noted that the execution of the BF setting involves BF training described above with reference to FIG. 5 or BF tracking explained with reference to FIGS. 6 and 7.

At the end of the BF setting, the process comes to an end for the moment. Thereafter, in the case where meta information is detected in the content (for example, in step S12), the same steps as those described above are repeated.

That is, in the case where, in step S12, the BF setting detection process is performed and meta information is detected in the content, a BF setting start trigger is output to the wireless repeating apparatus 12 as the BF setting execution information.

In steps S22 and S32, the HMD 13 and the wireless repeating apparatus 12 perform the BF setting process. Thereafter, in the case where meta information is detected in the content, the same steps as those described above are repeated.

FIG. 11 is a flowchart explaining the BF setting detection process performed in step S11 of FIG. 10.

The BF setting detection process in FIG. 11 is a process performed by the entertainment apparatus 11.

In step S51, the content analysis section 52 analyzes the currently reproduced content.

In step S52, the content analysis section 52 determines whether or not there is meta information. In the case where it is determined in step S52 that there is no meta information, control is returned to step S51 and the subsequent steps are repeated.

In the case where it is determined in step S52 that there is meta information, control is transferred to step S53. The content analysis section 52 extracts meta information and outputs the meta information to the control section 51.

In step S53, the control section 51 analyzes the meta information.

In step S54, the control section 51 determines whether or not it is time to control the BF setting, on the basis of the analyzed meta information.

In the case where it is determined in step S54 that it is time to control the BF setting, control is transferred to step S55. The control section 51 generates BF setting execution information, based on the analyzed meta information.

In step S55, the control section 51 transmits the BF setting execution information (e.g., start trigger in FIG. 10) to the wireless repeating apparatus 12 via the external IF section 56.

On the other hand, in the case where it is determined in step S54 that it is not time to control the BF setting, control is returned to step S53 and the subsequent steps are repeated.

In step S56, the control section 51 determines whether or not to terminate the BF setting, on the basis of the meta information. For example, in the case where the meta information includes a BF cycle or a BF setting end trigger, it is determined in step S56 that the BF setting is not to be terminated. Control is then returned to step S54 and the subsequent steps are repeated.

In the case where the meta information has no parameters required to be controlled, it is determined in step S56 that the BF setting is to be terminated. The BF setting detection process is then brought to an end.

FIG. 12 is a flowchart explaining a BF setting process performed in step S21 of FIG. 10.

The BF setting process in FIG. 12 is a process carried out by the wireless repeating apparatus 12.

The BF setting execution information transmitted from the entertainment apparatus 11 is supplied to the control section 71 via the external IF section 72.

In step S71, the control section 71 waits until determining that the BF setting execution information is received. In the case where it is determined in step S71 that the BF setting execution information is received, control is transferred to step S72.

In step S72, the control section 71 analyzes the BF setting execution information.

In step S73, the control section 71 determines whether or not it is time for the BF setting, on the basis of the result of analyzing the BF setting execution information. In the case where it is determined in step S73 that it is time for the BF setting, control is transferred to step S74.

In step S74, the control section 71 causes the wireless communication section 74 to start the BF setting.

On the other hand, in the case where it is determined in step S73 that it is not time for the BF setting, control is returned to step S72 and the subsequent steps are repeated.

In step S75, the control section 71 determines whether or not the BF setting is terminated. In the case where it is determined in step S75 that the BF setting is not terminated, control is returned to step S73 and the subsequent steps are repeated.

In the case where it is determined in step S75 that the BF setting is terminated, the BF setting process is brought to an end.

### <Second Process Example>

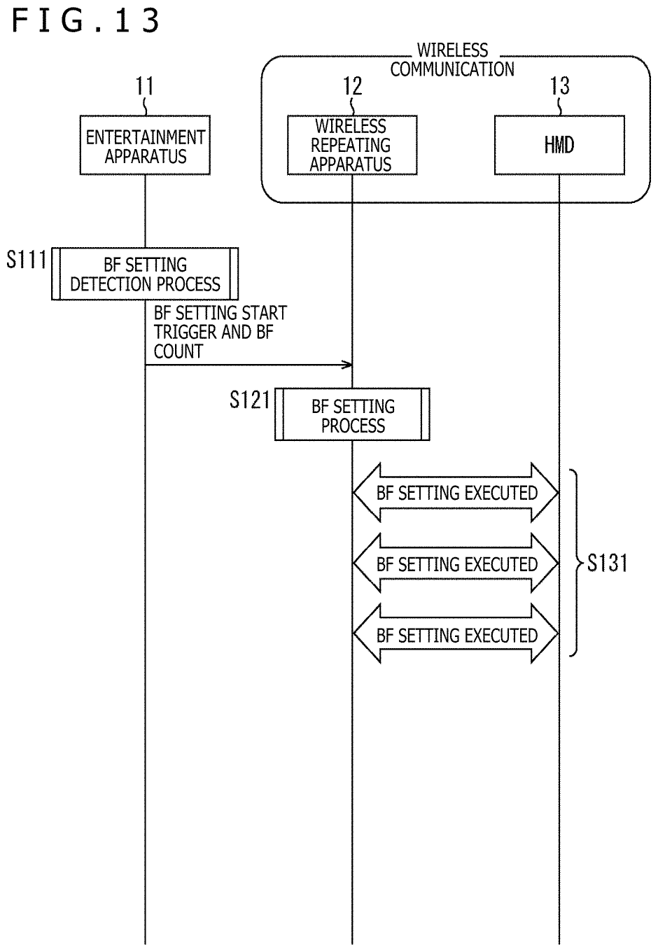

FIG. 13 is a flowchart explaining a second process of the wireless communication system.

The second process example depicted in FIG. 13 is performed in the case where a BF setting start trigger and a BF sequence count are included as the meta information. In the case of the example in FIG. 13, the BF sequence count is 3. The process in FIG. 13 is started when content is being reproduced by the entertainment apparatus 11.

In step S111, the entertainment apparatus 11 performs a BF setting detection process. The BF setting detection process is basically similar to the detection process described above with reference to FIG. 11 and thus will not be explained further. When the BF setting detection process is carried out in step S111, the BF setting start trigger and the BF sequence count are transmitted to the wireless repeating apparatus 12 as the BF setting execution information.

The wireless repeating apparatus 12 receives the BF setting start trigger and the BF sequence count transmitted from the entertainment apparatus 11.

In step S121, the wireless repeating apparatus 12 performs a BF setting process. This BF setting process is basically similar to the BF setting process described above with reference to FIG. 12 and thus will not be explained further. The BF setting process causes the BF setting to be executed.

Corresponding to the processing of the wireless repeating apparatus 12, the HMD 13 executes the BF setting in step S131 in conjunction with the wireless repeating apparatus 12. It is to be noted that the BF setting is executed as many times as the BF sequence count (3).

After the BF setting has been executed as many times as the BF sequence count, the process is terminated for the moment. Thereafter, in the case where a start trigger and a BF sequence count are detected in the content, the above-described steps are repeated.

### <Third Process Example>

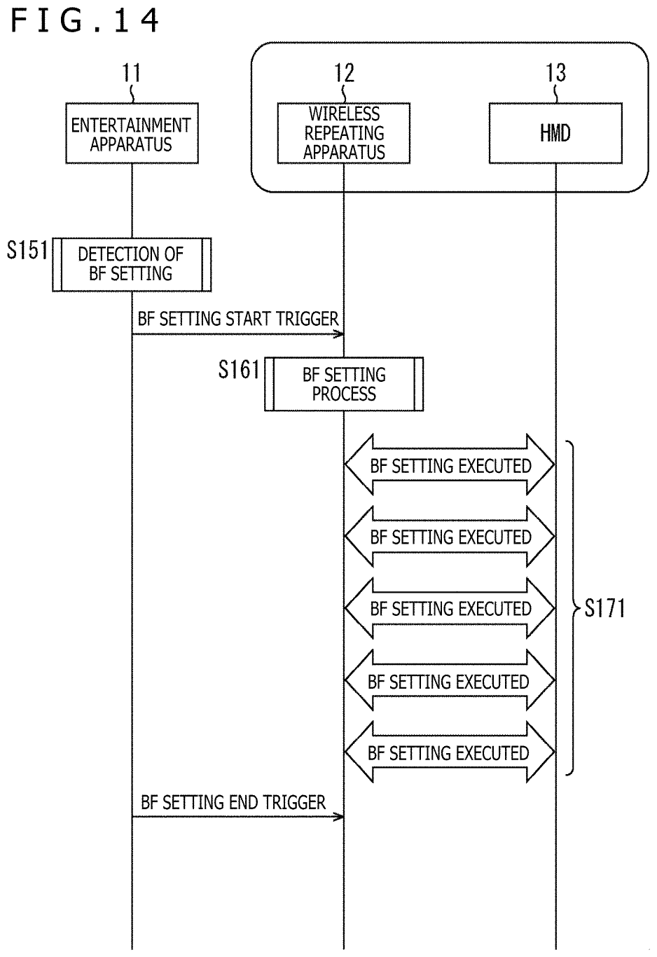

FIG. 14 is a flowchart explaining a third process of the wireless communication system.

The third process example depicted in FIG. 14 is a process in a case where a BF setting start trigger and a BF setting end trigger are included as the meta information. It is to be noted that a basically similar process is carried out in the case where a BF setting start time and a BF setting end time are included as the meta information. The process in FIG. 14 is started when content is being reproduced by the entertainment apparatus 11.

In step S151, the entertainment apparatus 11 performs a BF setting detection process. The BF setting detection process is basically similar to the detection process described above with reference to FIG. 11 and thus will not be explained further. When the BF setting detection process is carried out in step S151, the BF setting start trigger is output to the wireless repeating apparatus 12 as the BF setting execution information.

The wireless repeating apparatus 12 receives the BF setting start trigger transmitted from the entertainment apparatus 11.

In step S161, the wireless repeating apparatus 12 performs a BF setting process. This BF setting process is basically similar to the BF setting process described above with reference to FIG. 12 and thus will not be explained further. The BF setting process causes the BF setting to be executed.

Corresponding to the processing of the wireless repeating apparatus 12, the HMD 13 executes the BF setting in step S171 in conjunction with the wireless repeating apparatus 12. It is to be noted that the BF setting is executed repetitively until the wireless repeating apparatus 12 receives the BF setting end trigger transmitted by the entertainment apparatus 11 as the BF setting execution information on the basis of the meta information.

In the case in FIG. 14, the BF setting is executed five times after the BF setting start trigger is received by the wireless repeating apparatus 12 and until the BF setting end trigger is transmitted by the entertainment apparatus 11 on the basis of the meta information and is received by the wireless repeating apparatus 12.

When the BF setting end trigger brings the BF setting to an end, the process is terminated for the moment. Thereafter, the above-described steps are repeated in the case where a start trigger and an end trigger are detected again in the content.

### <Fourth Process Example>

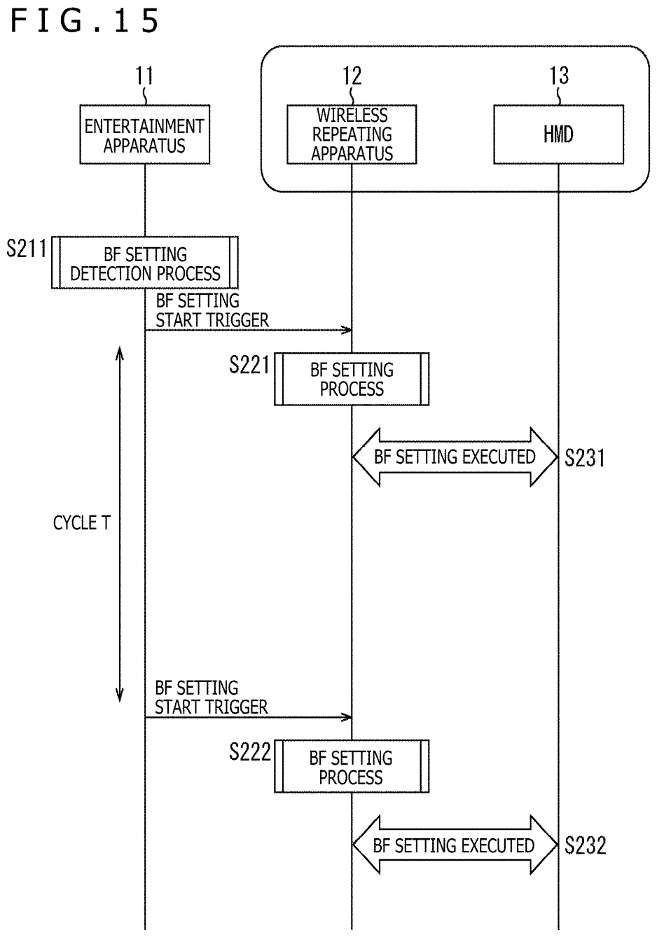

FIG. 15 is a flowchart explaining a fourth process of the wireless communication system.

The fourth process example depicted in FIG. 15 is a case where a BF setting start trigger, a cycle T, and a BF sequence count are included as the meta information. In the case of the example in FIG. 15, the BF sequence count is one. The process in FIG. 15 is started when content is being reproduced by the entertainment apparatus 11.

In step S211, the entertainment apparatus 11 performs a BF setting detection process. The BF setting detection process is basically similar to the detection process described above with reference to FIG. 11 and thus will not be explained further. When the BF setting detection process is carried out in step S211, the BF setting start trigger and the BF sequence cycle are transmitted to the wireless repeating apparatus 12 as the BF setting execution information.

The wireless repeating apparatus 12 receives the BF setting start trigger transmitted from the entertainment apparatus 11.

In step S221, the wireless repeating apparatus 12 performs a BF setting process. This BF setting process is basically similar to the BF setting process described above with reference to FIG. 12 and thus will not be explained further. The BF setting process causes the BF setting to be executed.

Corresponding to the processing of the wireless repeating apparatus 12, the HMD 13 executes the BF setting in step S231 in conjunction with the wireless repeating apparatus 12. It is to be noted that the BF setting is executed as many times as the BF sequence count (1).

After the BF setting has been executed as many times as the BF sequence count, the above-described steps are repeated every time the cycle T elapses.

That is, upon elapse of the cycle T, the control section 51 of the entertainment apparatus 11 outputs the BF setting start trigger to the wireless repeating apparatus 12 as the BF setting execution information.

In step S222, the wireless repeating apparatus 12 performs a BF setting process. The processing in step S222 causes the BF setting to be started.

Corresponding to the processing of the wireless repeating apparatus 12, the HMD 13 executes the BF setting in step S232 in conjunction with the wireless repeating apparatus 12. It is to be noted that the BF setting is executed as many times as the BF sequence count (1).

After the BF setting has been executed as many times as the BF sequence count, the above-described steps are repeated every time the cycle T elapses until an end instruction is given, for example.

Alternatively, the BF setting depicted in FIGS. 10 and 13 to 15 may be executed in parallel. Further, the meta information in the content may further include such parameters as a BF parameter range, a pattern, and a BF detection threshold value.

For example, the BF parameter range is a range of the ID attached to the radio waves to be selected in the BF. The pattern may, for example, be information indicative of using either BF training or BF tracking as the method for the BF setting.

Further, in BF setting, the combinations of the parameters in the meta information are not limited to those of the above-described examples; different combinations of the meta information parameters may be used instead.

### <6. Alternative Examples of the Wireless Communication System>

### <First Alternative Example>

In the wireless communication system of FIG. 1, the entertainment apparatus 11 extracts the meta information placed in the content and generates the BF setting execution information accordingly.

In the wireless communication system of a first alternative example, the entertainment apparatus 11 predicts the occurrence of activity of the user of the HMD 13, based on the result of analyzing content images, and generates the BF setting execution information accordingly.

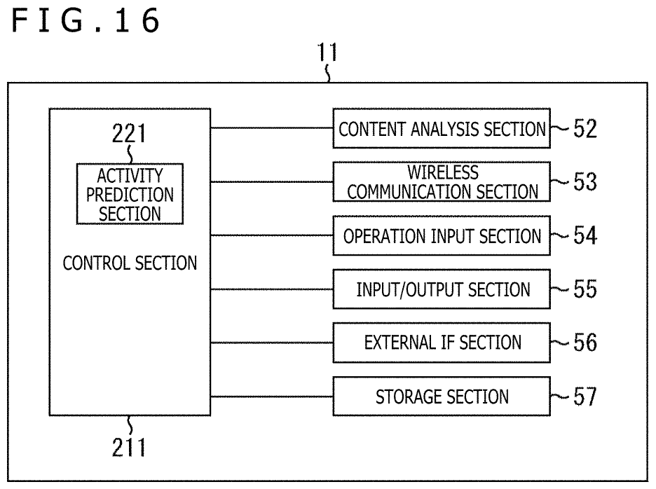

FIG. 16 is a block diagram depicting a configuration example of the entertainment apparatus 11.

The constituent elements in FIG. 16 that are the same as those explained above with reference to FIG. 2 are represented by the same reference signs. The repetitive explanations of these constituent elements will be omitted where appropriate.

The entertainment apparatus 11 includes a control section 211, the content analysis section 52, the wireless communication section 53, the operation input section 54, the input/output section 55, the external IF section 56, and the storage section 57.

The control section 211 causes a CPU to execute predetermined programs to perform diverse arithmetic processing and operation control of the various sections. By so doing, the control section 211 controls the operations of the entertainment apparatus 11 as a whole.

The control section 211 depicted in FIG. 16 is configured differently from the control section 51 in FIG. 2 in that the control section 211 includes an activity prediction section 221.

The activity prediction section 221 predicts the activity of the user of the HMD 13 on the basis of the result of analyzing the content images supplied from the content analysis section 52.

The control section 211 generates BF setting execution information, based on the result of the prediction from the activity prediction section 221. The BF setting execution information is output to the wireless repeating apparatus 12 via the external IF section 56.

The content analysis section 52 analyzes the currently reproduced content images, and outputs the result of the analysis to the activity prediction section 221.

It is to be noted that the processing steps performed by the wireless communication system of the first alternative example are basically similar to those discussed above with reference to FIG. 10 except for step S11 in which the BF setting detection process is carried out. Solely the BF setting detection process different from that of the wireless communication system in FIG. 1 is explained below as the processing step of the wireless communication system of the first alternative example.

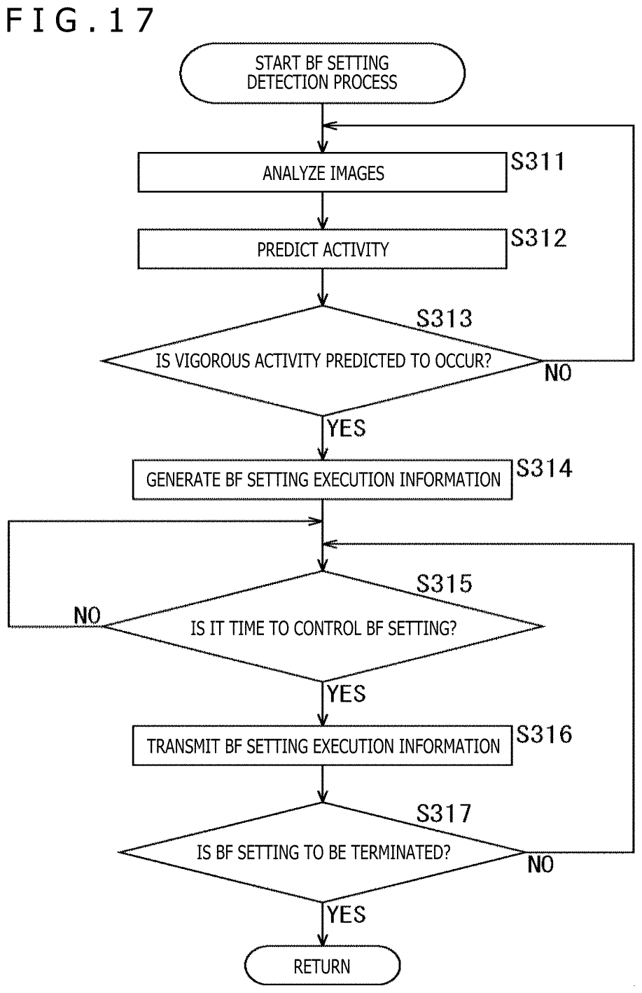

FIG. 17 is a flowchart explaining another example of the BF setting detection process performed in step S11 of FIG. 10.

The BF setting detection process in FIG. 17 is a process performed by the entertainment apparatus 11 in FIG. 16.

In step S311, the content analysis section 52 analyzes the currently reproduced content images, and outputs the result of the analysis to the activity prediction section 221.

In step S312, the activity prediction section 221 predicts the activity of the user of the HMD 13 on the basis of the analysis result supplied from the content analysis section 52, and outputs the result of the prediction to the control section 211.

In step S313, the control section 211 determines whether or not a vigorous activity of the user of the HMD 13 is predicted to occur, on the basis of the prediction result supplied from the activity prediction section 221. Whether or not the vigorous activity is predicted to occur is determined by use of a threshold value related to the magnitude of activity.

In the case where it is determined in step S313 that the vigorous activity is not predicted to occur, control is returned to step S311 and the subsequent steps are repeated.

In the case where it is determined in step S313 that the vigorous activity is predicted to occur, control is transferred to step S314.

In step S314, the control section 211 generates BF setting execution information.

In step S315, the control section 211 waits until determining whether or not it is time to control the BF setting, on the basis of the BF setting execution information.

In the case where it is determined in step S315 that it is time to control the BF setting, control is transferred to step S316.

In step S316, the control section 211 outputs the BF setting execution information (e.g., start trigger or end trigger in FIG. 14) to the wireless repeating apparatus 12 via the external IF section 56.

In step S317, the control section 211 determines whether or not to terminate the BF setting, based on the BF setting execution information. In the case where there is a parameter required to be controlled in the BF setting execution information, it is determined in step S317 that the BF setting is not to be terminated. Control is then returned to step S315 and the subsequent steps are repeated.

In the case where there is no parameter required to be controlled in the BF setting execution information, it is determined in step S317 that the BF setting is to be terminated. This brings the BF setting execution process to an end.

In the wireless communication system of the first alternative example, as described above, the activity of the user of the HMD 13 is predicted on the basis of the result of analyzing content images. The BF execution information is then generated on the basis of the result of the prediction. This makes it possible to execute the BF setting before the activity of the user of the HMD 13 becomes vigorous.

### <Second Alternative Example>

In the wireless communication system of a second alternative example, the HMD 13 analyzes captured images or sensor data and generates BF setting execution information accordingly.

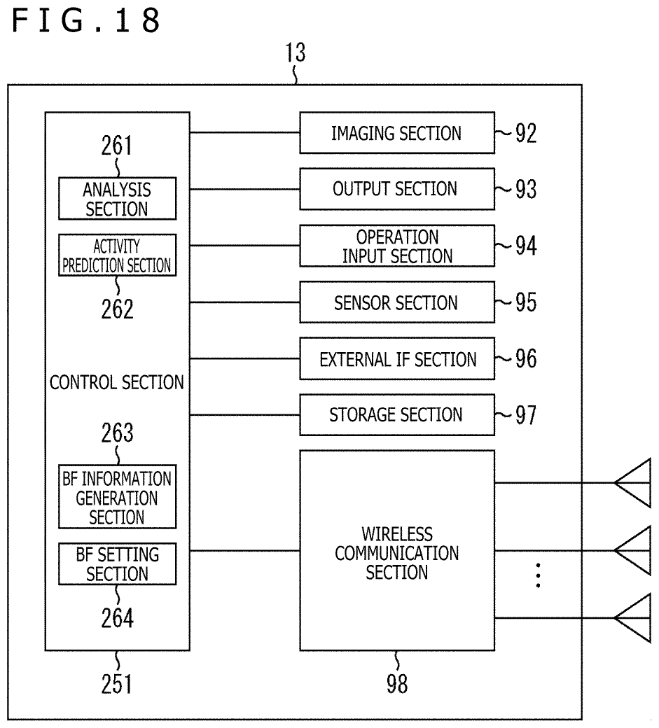

FIG. 18 is a block diagram depicting a configuration example of the HMD 13.

The constituent elements in FIG. 18 that are the same as those explained above with reference to FIG. 4 are represented by the same reference signs. The repetitive explanations of these constituent elements will be omitted where appropriate.

The HMD 13 includes a control section 251, the imaging section 92, the output section 93, the operation input section 94, the sensor section 95, the external IF section 96, the storage section 97, and the wireless communication section 98.

The control section 251 causes a CPU to execute predetermined programs to perform diverse arithmetic processing and operation control of the various sections. By so doing, the control section 251 controls the operations of the HMD 13 as a whole.

The control section 251 depicted in FIG. 18 is configured differently from the control section 91 in FIG. 2 in that the control section 251 includes an analysis section 261, an activity prediction section 262, a BF information generation section 263, and a BF setting section 264.

The analysis section 261 analyzes the images obtained by the imaging section 92 or the sensor data supplied from the sensor section 95. The analysis section 261 supplies the result of analyzing the images or the sensor data to the activity prediction section 262.

The activity prediction section 262 predicts the activity of the user of the HMD 13 on the basis of the result of the image analysis or sensor data analysis supplied from the analysis section 261. The activity prediction section 262 supplies the result of the prediction to the BF information generation section 263.

The BF information generation section 263 generates BF setting execution information, based on the prediction result supplied from the activity prediction section 262.

The BF setting section 264 controls the wireless communication section 98 to start the BF setting, on the basis of the BF setting execution information.

That is, in the wireless communication system of FIG. 1, the wireless repeating apparatus 12 starts the BF setting as the initiator, on the basis of the BF setting execution information supplied from the entertainment apparatus 11. In the wireless communication system of the second alternative example, the HMD 13 starts the BF setting as the initiator, on the basis of the BF setting execution information generated by the HMD 13.

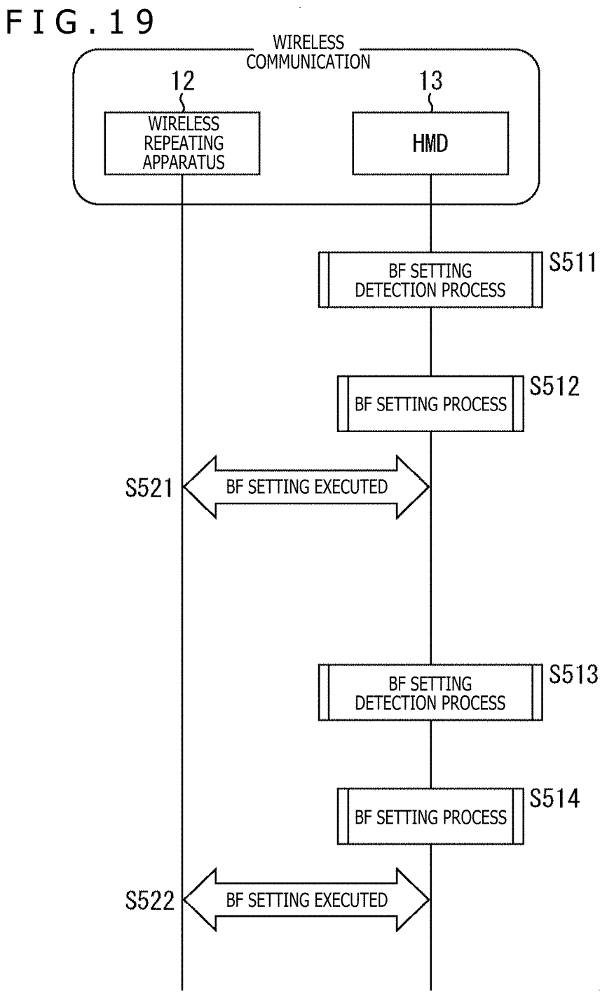

FIG. 19 is a flowchart explaining processing of the wireless communication system of the second alternative example.

In the case in FIG. 19, as with the wireless communication system of FIG. 1, the images reproduced by the entertainment apparatus 11 are transmitted from the wireless repeating apparatus 12 to the HMD 13 by millimeter wave wireless communication. Alternatively, the images captured by the HMD 13 are transmitted therefrom to the wireless repeating apparatus 12 by millimeter wave wireless communication.

For example, the imaging section 92 of the HMD 13 starts capturing images. The images thus captured are output to the analysis section 261. In addition, the sensor section 95 starts measurement. The sensor data obtained by measurement is output to the analysis section 261.

In step S511, the analysis section 261, the activity prediction section 262, and the BF information generation section 263 perform a BF setting detection process. This BF setting detection process is basically similar to the BF setting detection process described above with reference to FIG. 17 and thus will not be explained further. The processing in step S511 causes the activity to be predicted on the basis of the result of the analysis. The BF setting execution information is then generated and output to the BF setting section 264.

The BF setting section 264 acquires the BF setting execution information supplied from the BF information generation section 263.

In step S512, the BF setting section 264 performs a BF setting process. This BF setting process is basically similar to the BF setting process described above with reference to FIG. 12 and thus will not be explained further. The processing in step S512 causes the BF setting to be executed.

Corresponding to the above processing, the wireless repeating apparatus 12 executes the BF setting in step S521 in conjunction with the HMD 13. It is to be noted that the execution of the BF setting involves BF training of FIG. 5 or BF tracking of FIGS. 6 and 7.

At the end of the BF setting, the process is terminated for the moment. Thereafter, in the case where the activity is again predicted to occur (e.g., in step S513), the above-described steps are repeated.

In the wireless communication system of the second alternative example, as described above, the activity of the HMD 13 is predicted on the basis of analyzing the captured images or the measured sensor data. The BF execution information is then generated on the basis of the result of the prediction. This makes it possible to execute the BF setting before the activity of the HMD 13 becomes vigorous.

### <Third Alternative Example>

In the wireless communication system of a third alternative example, as in the case of the wireless communication system of the second alternative example, the HMD 13 predicts the activity, based on the result of analyzing the captured images or the sensor data. The BF setting execution information is then generated.

Below is a detailed description of this example again with reference to FIG. 18. The repetitive explanations will be omitted hereunder where appropriate.

The analysis section 261 of the HMD 13 analyzes the images obtained by the imaging section 92 or the sensor data supplied from the sensor section 95. The activity prediction section 262 predicts the activity of the user of the HMD 13 on the basis of the result of analyzing the images or the sensor data supplied from the analysis section 261. For example, in the case where the imaging section 92 is capturing images of outdoor traffic lights, the imaging section 92 supplies the traffic light images to the analysis section 261.

The analysis section 261 supplies the result of the image analysis to the activity prediction section 262. The activity prediction section 262 predicts the user's activity, based on the image analysis result supplied from the analysis section 261, and supplies the result of the prediction to the BF information generation section 263.

For example, the user in a stationary state is predicted to start walking the moment the traffic lights change to green from red given the currently captured images. Likewise, the moment the traffic lights change from yellow to red, the user is predicted to stop walking or to come to an abrupt halt.

The BF information generation section 263 turns on/off the BF setting in the case where the activity of the user of the HMD 13 is predicted to occur given the currently captured images, such as at the moment the traffic lights change from red to green or from yellow to red. That is, in the case where the activity of the user of the HMD 13 is predicted to occur, the BF information generation section 263 generates the BF setting execution information. In the case where the activity of the user of the HMD 13 is not predicted to occur, the BF information generation section 263 does not execute the BF setting and thus does not generate the BF setting execution information.

It is to be noted that the processing of the wireless communication system of the third alternative example is basically similar to the processing described above with reference to FIG. 19 and thus will not be explained further.

In the wireless communication system of the third alternative example, as described above, occurrence of the activity of the HMD 13 is predicted, on the basis of the result of analyzing images and sensor data. The BF setting execution information is then generated on the basis of the result of the prediction. This makes it possible to execute the BF setting before the activity of the HMD 13 becomes vigorous.

Explained above were the cases where the user makes use of the HMD 13 as the device of choice. Alternatively, the HMD 13 may be replaced with a smartphone having an imaging section, a tablet terminal, or a car-mounted device as the device of choice for the user. In the case with such a device in use, millimeter wave wireless communication is assumed to be conducted over public networks.

The present technology enables the communication section performing wireless communication to execute the beam forming setting in a manner linked with content.

Thus, according to the present technology, the BF setting is carried out at an optimal timing synchronized with the user's activity before communication channel characteristics deteriorate. Further, with the robustness of wireless communication thus increased, the quality of communication is enhanced correspondingly.

Further, because the BF is executed before activation of communication equipment, the effect on the data communication bandwidth is minimized.

Whereas the present technology has been explained on the assumption that millimeter wave wireless communication is used, the present technology may also be applied to wireless communication arrangements other than the millimeter wave wireless communication.

### <7. Computer>

### <Hardware Configuration Example of the Computer>

The series of the processing described above may be executed either by hardware or by software. Where the series of the processing is to be carried out by software, the programs constituting the software are installed into a suitable computer. Here, variations of the computer include one with the software installed beforehand in its dedicated hardware and a general-purpose personal computer or like equipment capable of executing diverse functions based on the programs installed therein.

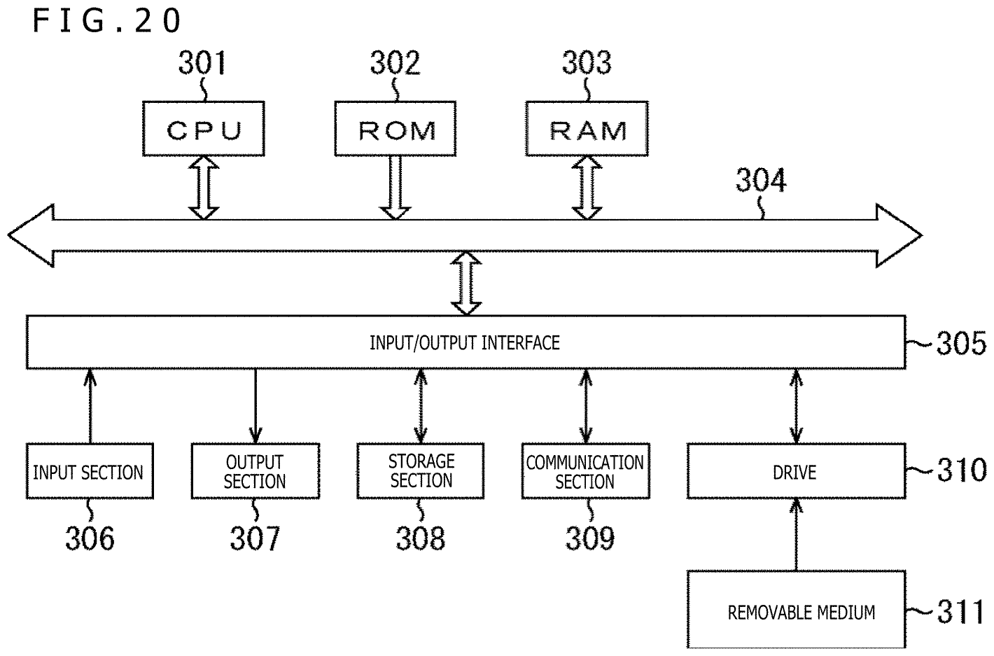

FIG. 20 is a block diagram depicting a hardware configuration example of a computer that executes the above-described series of the processing by using programs.

In the computer, a CPU (Central Processing Unit) 301, a ROM (Read Only Memory) 302, and a RAM (Random Access Memory) 303 are interconnected via a bus 304.

The bus 304 is further connected with an input/output interface 305. The input/output interface 305 is connected with an input section 306, an output section 307, a storage section 308, a communication section 309, and a drive 310.

The input section 306 includes a keyboard, a mouse, and a microphone, for example. The output section 307 includes a display and speakers, for example. The storage section 308 includes a hard disk and a nonvolatile memory, for example. The communication section 309 includes a network interface, for example. The drive 310 drives a removable medium 311 such as a magnetic disk, an optical disk, a magneto-optical disk, or a semiconductor memory.

In the computer configured as described above, the CPU 301 performs, for example, the above-mentioned series of the processing by loading appropriate programs stored in the storage section 308 into the RAM 303 via the input/output interface 305 and the bus 304 and by executing the loaded programs.

The programs to be executed by the computer (CPU 301) may be recorded, for example, on the removable medium 311 as a packaged medium, when offered. The programs may also be offered via a wired or wireless transmission medium such as a local area network, the Internet, and digital satellite broadcasting.

In the computer, the programs may be installed into the storage section 308 from the removable medium 311 attached to the drive 310, via the input/output interface 305. The programs may also be installed into the storage section 308 after being received by the communication section 309 via a wired or wireless transmission medium. The programs may alternatively be preinstalled in the ROM 302 or in the storage section 308.

It is to be noted that the programs to be executed by the computer may each be processed chronologically, i.e., in the sequence explained in this description, in parallel with other programs, or in otherwise appropriately timed fashion such as when the program is invoked as needed.

Further, in this description, the term “system” refers to an aggregate of multiple components (e.g., apparatuses or modules (parts)). It does not matter whether or not all components are housed in the same enclosure. Thus, a system may be configured with multiple apparatuses housed in separate enclosures and interconnected via a network, or with a single apparatus in a single enclosure that houses multiple modules.

It is to be noted that the advantageous effects stated in this description are only examples and not limitative of the present technology that may also provide other advantageous effects.

The present technology is not limited to the preferred embodiments discussed above and may be implemented in diverse variations so far as they are within the scope of the present technology.

For example, the present technology may be implemented as a cloud computing setup in which a single function is processed cooperatively by multiple networked apparatuses on a shared basis.

Also, each of the steps discussed in reference to the above-described flowcharts may be executed either by a single apparatus or by multiple apparatuses on a shared basis.

Furthermore, in the case where a single step includes multiple processes, the multiple processes included in the single step may be executed either by a single apparatus or by multiple apparatuses on a shared basis.

### [Typical Combinations of the Configured Components]

The present disclosure may also be implemented in the following configurations.

(1)

A communication control apparatus including: a control section configured to cause a communication section performing wireless communication to execute beam forming setting in a manner linked with content.

(2)

The communication control apparatus as stated in paragraph (1) above, further including:

the communication section configured to execute the beam forming setting.

(3)

The communication control apparatus as stated in paragraph (1) or (2) above, in which the control section causes the beam forming setting to be executed, based on execution information regarding the beam forming setting.

(4)

The communication control apparatus as stated in paragraph (3) above, in which the execution information includes trigger information indicative of a start of the beam forming setting.

(5)

The communication control apparatus as stated in paragraph (3) above, in which the execution information includes at least one from among a start time of the beam forming setting, an end time of the beam forming setting, a beam forming count, a beam forming range, a beam forming pattern, a beam forming cycle, and a beam forming threshold value.

(6)

The communication control apparatus as stated in any one of paragraphs (3) to (5) above, in which the execution information is included in the content.

(7)

The communication control apparatus as stated in any one of paragraphs (3) to (6) above, in which the execution information includes information that indicates a scene in which a user of an apparatus conducting the wireless communication with the communication section is predicted to act.

(8)

The communication control apparatus as stated in paragraph (7) above, in which the execution information is placed before data of the scene in the content.

(9)

The communication control apparatus as stated in any one of paragraphs (3) to (8) above, further including:

an analysis section configured to analyze the content,

in which the control section generates the execution information, based on a result of the analysis by the analysis section.

(10)

The communication control apparatus as stated in any one of paragraphs (3) to (5) above, further including:

an analysis section configured to analyze an image of the content,

in which the control section generates the execution information by predicting, on the basis of a result of the analysis by the analysis section, an activity of a user of an apparatus conducting the wireless communication with the communication section.

(11)

The communication control apparatus as stated in any one of paragraphs (3) to (5) above, further including:

an imaging section configured to generate an image by capturing a subject; and

an analysis section configured to analyze at least either the image generated by the imaging section or information from a sensor arranged on an apparatus housing,

in which the control section generates the execution information by predicting, on the basis of the result of the analysis by the analysis section, an activity of a user of an apparatus conducting the wireless communication with the communication section.

(12)

A communication control method including:

enabling a communication control apparatus to cause a communication section performing wireless communication to execute beam forming setting in a manner linked with content.

(13)

A communication apparatus including:

a communication section configured to execute beam forming setting of wireless communication in conjunction with another communication apparatus, under such control that the beam forming setting is executed in a manner linked with content.

(14)

A communication method including causing a communication apparatus to execute beam forming setting of wireless communication in conjunction with another communication apparatus, under such control that the beam forming setting is executed in a manner linked with content.

### REFERENCE SIGNS LIST

11: Entertainment apparatus
12: Wireless repeating apparatus
13: HMD
51: Control section
52: Content analysis section
53: Wireless communication section
54: Operation input section
55: Input/output section
56: External IF section
57: Storage section
71: Control section
72: External IF section
73: Storage section
74: Wireless communication section
91: Control section
92: Imaging section
93: Display section
94: Operation input section
95: Sensor section
96: External IF section
97: Storage section
98: Wireless communication section
211: Control section
221: Activity prediction section
251: Control section
261: Analysis section
262: Activity prediction section
263: BF information generation section
264: BF setting section

1. A communication control apparatus comprising:
a control section configured to cause a communication section performing wireless communication to execute beam forming setting in a manner linked with content.

2. The communication control apparatus according to claim 1, further comprising:
the communication section configured to execute the beam forming setting.

3. The communication control apparatus according to claim 1, wherein the control section causes the beam forming setting to be executed, based on execution information regarding the beam forming setting.

4. The communication control apparatus according to claim 3, wherein the execution information includes trigger information indicative of a start of the beam forming setting.

5. The communication control apparatus according to claim 3, wherein the execution information includes at least one from among a start time of the beam forming setting, an end time of the beam forming setting, a beam forming count, a beam forming range, a beam forming pattern, a beam forming cycle, and a beam forming threshold value.

6. The communication control apparatus according to claim 3, wherein the execution information is included in the content.

7. The communication control apparatus according to claim 6, wherein the execution information includes information that indicates a scene in which a user of an apparatus conducting the wireless communication with the communication section is predicted to act.

8. The communication control apparatus according to claim 7, wherein the execution information is placed before data of the scene in the content.

9. The communication control apparatus according to claim 3, further comprising:
an analysis section configured to analyze the content,
wherein the control section generates the execution information, based on a result of the analysis by the analysis section.

10. The communication control apparatus according to claim 3, further comprising:
an analysis section configured to analyze an image of the content,
wherein the control section generates the execution information by predicting, on a basis of a result of the analysis by the analysis section, an activity of a user of an apparatus conducting the wireless communication with the communication section.

11. The communication control apparatus according to claim 3, further comprising:
an imaging section configured to generate an image by capturing a subject; and
an analysis section configured to analyze at least either the image generated by the imaging section or information from a sensor arranged on an apparatus housing,
wherein the control section generates the execution information by predicting, on a basis of the result of the analysis by the analysis section, an activity of a user of an apparatus conducting the wireless communication with the communication section.

12. A communication control method comprising:
enabling a communication control apparatus to cause a communication section performing wireless communication to execute beam forming setting in a manner linked with content.

13. A communication apparatus comprising:
a communication section configured to execute beam forming setting of wireless communication in conjunction with another communication apparatus, under such control that the beam forming setting is executed in a manner linked with content.

14. A communication method comprising:
causing a communication apparatus to execute beam forming setting of wireless communication in conjunction with another communication apparatus, under such control that the beam forming setting is executed in a manner linked with content.
